(19) United States
(12) Patent Application Publication
(10) Pub. No.: US 2003/0051972 A1
(43) Pub. Date: Mar. 20, 2003

(54) Automated immersion processing system

(75) Inventor: Jeffry Davis, Kalispell, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/199,997

(22) Filed: Jul. 19, 2002

Related U.S. Application Data
(63) Continuation-in-part of application No. 09/612,009, filed on Jul. 7, 2000.
Application No. 09/612,009 is a continuation-in-part of application No. 09/274,511, filed on Mar. 23, 1999, now Pat. No. 6,279,724.
Application No. 09/274,511 is a continuation-in-part of application No. 09/112,259, filed on Jul. 8, 1998, now Pat. No. 6,273,110.
Application No. 09/112,259 is a continuation-in-part of application No. 08/994,737, filed on Dec. 19, 1997, now Pat. No. 6,447,232.
Application No. 08/994,737 is a continuation-in-part of application No. 08/851,480, filed on May 5, 1997, now abandoned.
(63) Continuation-in-part of application No. 09/611,507, filed on Jul. 7, 2000, now Pat. No. 6,439,824.

(51) Int. Cl. B65G 15/64; B65G 21/22; B65G 47/22; B65G 47/24

(52) U.S. Cl. 198/345.3

(57) ABSTRACT

An automated processing system has an indexer bay perpendicularly aligned with a process bay within a clean air enclosure. An indexer in the indexer bay provides stocking or storage for work in progress wafers. Immersion and spin process modules are located in the process bay. A process robot moves between the indexer bay and process bay to carry wafers to and from the process modules. The wafers are processed within a carrier, reducing the potential for physical damage to the wafers. The process robot hands the carrier off to a rotor, in the spin process modules, or to an immersion elevator in the immersion module. Both spin and immersion processing are performed within an automated system.

This application is a continuation-in-part of U.S. patent application Ser. No. 09/612,009, filed Jul. 7, 2000, and now pending, which is a continuation-in-part of U.S. patent application Ser. No. 09/274,511, filed Mar. 23, 1999 and now U.S. Pat. No. 6,279,724, which is a continuation-in-part of U.S. patent application Ser. No. 09/112,259, filed Jul. 8, 1998, and now U.S. Pat. No. 6,273,110, which is a continuation-in-part of U.S. patent application Ser. No. 08/994,737, filed Dec. 19, 1997 and now pending, which is a continuation-in-part of U.S. patent application Ser. No. 08/851,480, filed May 5, 1997 and now abandoned. Priority to these applications is claimed under 35 USC §120, and these applications are incorporated herein by reference. This application is also a continuation-in-part of U.S. patent application Ser. No. 09/611,507, filed Jul. 7, 200, and now pending, and incorporated herein by reference. U.S. patent application Ser. No. 09/611,507 is also incorporated herein by reference.

The field of the invention is automated semiconducted wafer processing systems, used for processing semiconductor wafers, hard disk media, substrates, memory media, optical materials and masks, and similar materials requiring very low levels of contamination, collectively referred to here as “wafers.”

### BACKGROUND OF THE INVENTION

Computers, televisions, telephones and other electronic products contain large numbers of essential electronic semiconductor devices. To produce electronic products, hundreds or thousands of semiconductor devices are manufactured in a very small space, using lithography techniques on semiconductor substrates, such as on silicon wafers. Due to the extremely small dimensions involved in manufacturing semiconductor devices, contaminants on the semiconductor substrate material, such as particles of dust, dirt, paint, metal, etc. lead to defects in the end products.

To exclude contaminants, semiconductor substrates are processed within clean rooms. Clean rooms are enclosed areas or rooms within a semiconductor manufacturing facility, designed to keep out contaminants. All air provided to a clean room is typically highly filtered to prevent airborne contaminants from entering into or circulating within the clean room. Special materials and equipment are needed to maintain contaminants within the clean room at adequately low levels. Consequently, construction and maintenance of clean rooms can be time consuming and costly. As a result, the semiconductor processing equipment installed within a clean room should preferably be compact, so that large numbers of semiconductor wafers can be processed within a smaller space, thereby reducing space requirements and costs. Accordingly, there is a need for smaller automated processing equipment, to reduce clean room space requirements.

Wafers have been processed in spin or centrifugal processors, where various liquid or gas process chemicals are sprayed onto the wafers, while the wafers are spinning in a rotor. Rinse and dry liquids and gases, such as water and nitrogen or air, have also been applied this way. Wafers have also been processed by immersion into baths of liquid. Both centrifugal spray processing and immersion processing have advantages. Additional advantages may be realized with automated or computer controlled robot centrifugal spray or immersion processing systems. Still further advantages may be provided in performing process steps with the wafers held within a carrier. However, there remains a need for a processing system able to provide in combination, automated wafer movement, processing of wafers within a carrier, centrifugal spray processing, as well as immersion processing.

It is an object of the invention to provide an automated processing system, better designed to keep wafers or other articles or work pieces free of contaminants. It is a further object of the invention to provide an processing system that is versatile, yet compact, to reduce clean room space requirements.

Other objects, features and advantages will appear hereinafter. The various features described among the embodiments may of course be used individually or in differing combinations. The invention resides not only in the systems described, but also in the subcombinations and subsystems described.

### BRIEF DESCRIPTION OF THE DRAWINGS

In the drawings, wherein the same reference number denotes the same element throughout the several views:

FIG. 1 is a top, front and left side perspective view of the present automated processing system.

FIG. 2 is a rear, top, and left side perspective view of the system of FIG. 1.

FIG. 3 is a perspective view of an immersion module for use in the system shown in FIG. 1.

FIG. 4 is a perspective view thereof, showing the elevator in the up position.

FIG. 5 is a perspective view thereof, showing the elevator in the down position, with the carrier in the tank, and the tank lid open.

FIG. 6 is a perspective view thereof, with the tank lid closed, for immersion processing.

### DETAILED DESCRIPTION OF THE DRAWINGS

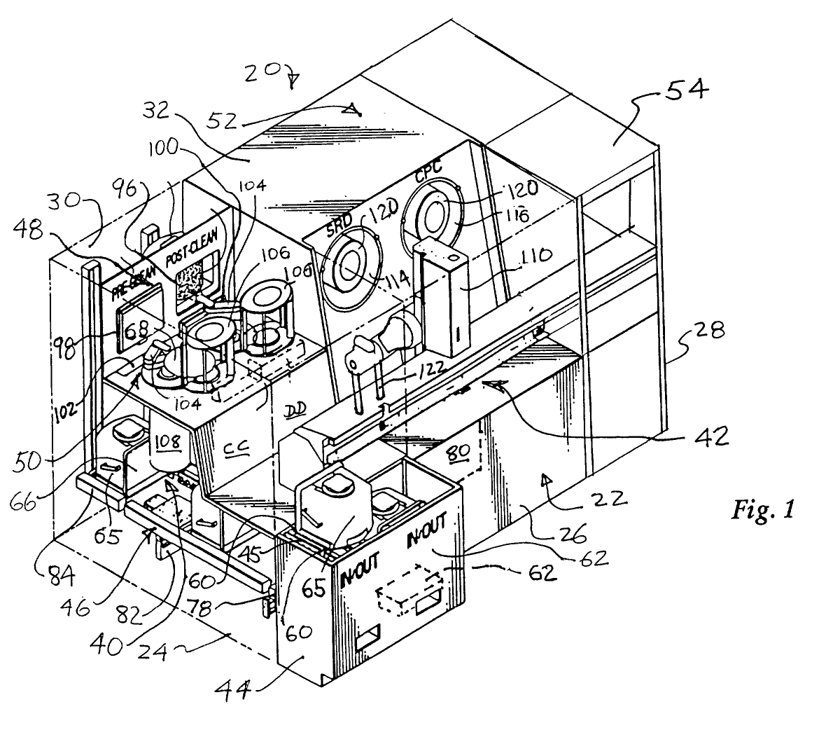

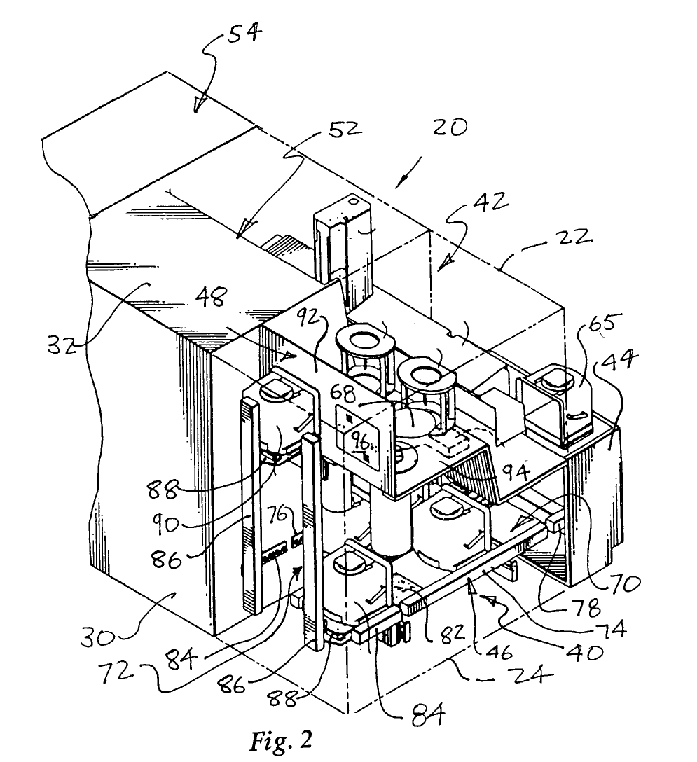

Referring now to FIGS. 1-2, an automated semiconductor processing system embodiment 20 has an enclosure 22 including a left side wall 24, right side wall 28, front wall 26, back wall 30, and a top wall 32. For purposes of explanation, the system 20 can be described as having an indexer or work-in-progress (WIP) space or bay 40, and a process space or bay 42, both within the enclosure 22.

The system 20 includes as major subsystems a loader 44, which may be outside of the enclosure 22, an indexer 46, a docking station 48, a transfer station 50, a spin process station or module 52, an immersion station or module 54, and a process robot 110, all within the enclosure 22. The indexer 46 and docking station 48 may be considered as subsystems within the indexer space 40, while the transfer station 50, the process stations 52 and 54, and the process robot 110 may be considered as subsystems within the process space 42.

The loader 44 is preferably positioned at the front wall 26, in alignment with the indexer 46. However, alternatively, the loader may be positioned at the left side wall 24.

The loader 44 has a load or first elevator 60 and an unload or second elevator 62. The elevators 60 and 62 are adapted to receive a closed or sealed pod 65 containing wafers 68, or other similar flat substrate media. The pod may be a FOUP, FOSBY or SMIF pod or container. A pod door 66 closes off or seals the open front end of the pod. The pods are used to store and transport wafers, during manufacture, while keeping the wafers free of contamination from particles, dust, etc.

The elevators 60 and 62 in the loader 44 move a pod from a load or up position down to position level with the indexer 46.

In the embodiment shown in the Figures, the pods are placed onto and removed from the load elevator 60 by hand. The pods have handles ergonomically positioned to better facilitate carrying the pod. Consequently, the pods are preferably placed and removed from the elevators 60 and 62 with the pod door 66 facing the back wall 30. To position the pod so that the wafers 68 within the pod may be accessed within the system 20, the loader 44 includes a pod rotator 45. The pod rotator operates to rotate a pod on the load elevator by 180°, so that the pod door is reoriented towards the front of the system. This reorientation by the pod rotator preferably occurs with the pod in the down position.

Referring to FIG. 2, the indexer 46 has a load or first row 70 including e.g., 2, 3 or 4 pod (typically input) positions and an unload or second row 72 having e.g., 2, 3 or 4 pod (typically output) positions. An input or first row conveyor 74 extends under the pod input positions, and a pod output or second row conveyor 76 extends under the pod output positions.

The conveyors 74 and 76, as well as load/unload conveyors 78 in the loader 44, have drive rollers and idler rollers, and one or more motors for driving the drive rollers. A computer/controller 80 is linked to and controls the conveyors, as well as other components and subsystems.

A shuttle device or robot 82 is positioned underneath the conveyors 74 and 76. The shuttle device 82 engages, lifts, and transfers pods between the rows 70 and 72 of the indexer 46.

Docking elevator conveyors 84 are aligned with the rows 70 and 72 of the indexer, preferably between the indexer and the back wall 30.

A docking station elevator 86 extends vertically from each of the docking elevator conveyors 84 to a docking station 48 positioned vertically above the indexer 46. Each elevator 86 has an engager plate 88, for engaging a bottom surface of a pod, to lift the pod off of the conveyor 84. The engager plate 88 is vertically movable along the elevator 86. The elevators 86 lift and lower the engager plates 88 via an electrically powered ball screw or equivalent actuators, linked to the controller 80.

An engager actuator 90 moves the engager plate 88 longitudinally, i.e., in a direction from the front wall 26 to the back wall 30.

A docking wall 92 at the docking station 48 and a deck 94 separate the indexer space 40 from the process space 42, although the deck 94 may be perforated or have openings to allow downward air flow through the system 20. The docking wall 92 has openings 96 and 98. Hence, a pod door 66 of a pod 65 on an engager plate 88 lifted by a docking elevator 86, aligns laterally and vertically (but initially not longitudinally) with an opening 96 or 98 in the docking wall 92. After the pod 65 is vertically aligned with an opening, the engager actuator 90 moves the pod forward, so that the front face of the pod contacts the docking wall 92. During other movement of the pod on the elevator 86, the engager actuator 90 is retracted, so that the pod is spaced apart from the docking wall and can be moved vertically without interference with the docking wall, or other components.

Referring to FIG. 1, a pod door remover 100 is provided at each of the openings 96 and 98 in the docking wall, to remove the pod door 66 from a docked pod. The pod door remover 100 removes the pod door and lowers it down through a pod door slot 102 in the deck 94. This unseals the pod and moves the pod door out of the way, so that wafers within the pod can be accessed. The design and operation of the pod door remover is set forth in International Patent Application Publication W099/32381 incorporated herein by reference.

The docking station 48 and transfer station 50 may be characterized as forming two side-by-side parallel rows CC and DD, for purposes of explanation, with the components and operations of the rows being the same. Referring once again to FIGS. 1-2, in rows CC and DD, transfer robots 104 in the transfer station are positioned to reach into docked pods, engage wafers in the pods, and transfer the wafers into carriers 106. The carrier is described in U.S. patent application Ser. No. 09/735,154, filed Dec. 12, 2000, now pending, and incorporated herein by reference. Each of the transfer robots 104 has an articulated arm, and an end effector or hand on the end of the arm, with the end effector adapted to engage a single wafer. An arm driver 108 is connected to the articulated arm, and has one or more motors for driving the arm segments, as controlled by the controller 80.

A reader/scanner may be provided in the transfer station, to identify individual wafers as they are moved from a pod into a carrier.

If desired, a prealigner may be located in the transfer station at a location accessible by a transfer robot so that individual wafers may be appropriately oriented after removal from a pod and before insertion into a carrier 106.

A process robot 110 moves laterally on a rail 112, between the transfer station 50, a first process module or chamber 114 (such as a spray acid chamber, or a spray solvent chamber), a second process module or chamber 116 (such as a spin rinser dryer), and an immersion module 54. Each process module 114 and 116 has a rotor 120 adapted to receive a carrier holding wafers. The system 20 is preferably configured and dimensioned for processing 300 mm diameter wafers. Other types and numbers of process stations may be substituted or added.

In an alternative embodiment, a single centrally located transfer robot 104 is provided, instead of two transfer robots. In addition, the pod rotator 45 can be provided on the elevator conveyors, rather than in the loader 44.

An end effector 122 attached to the arm of the process robot 110 is adapted to engage the carrier 106. The end effector has a pair of spaced apart blade-like fingers which engage slots and hooks in the carriers. Hence, the process robot can engage, lift, maneuver, and place the carriers holding the wafers.

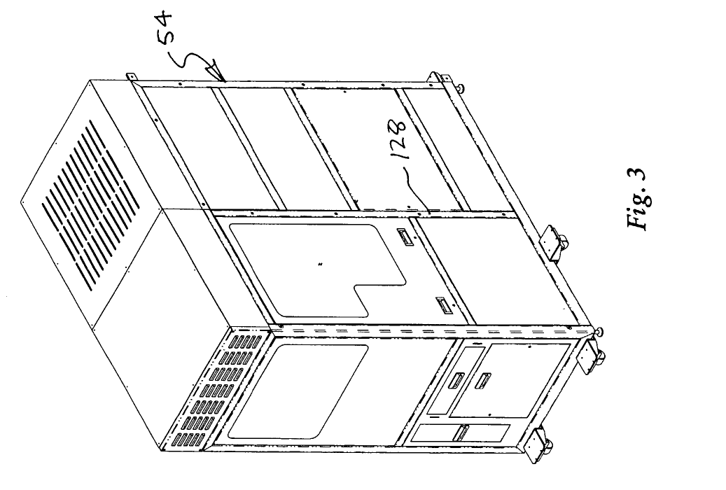

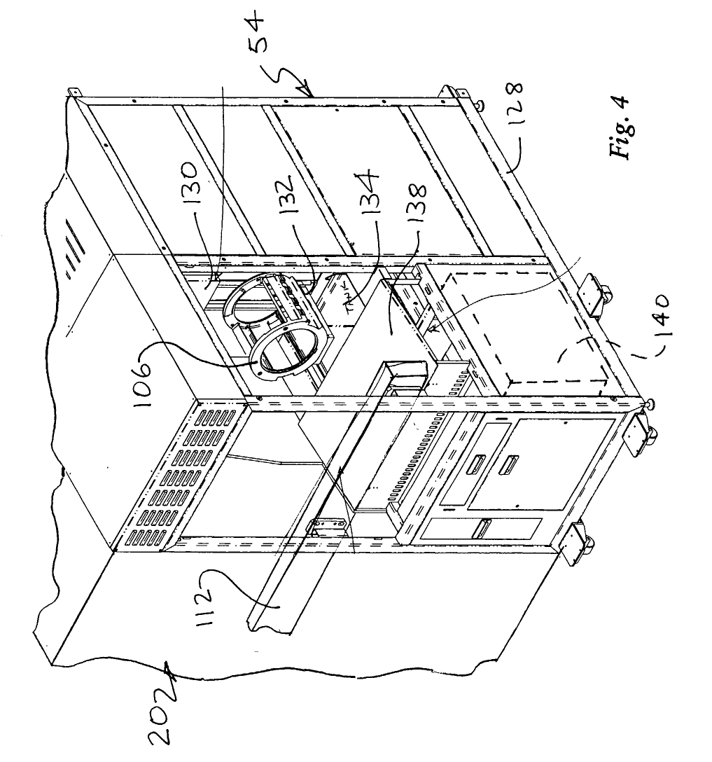

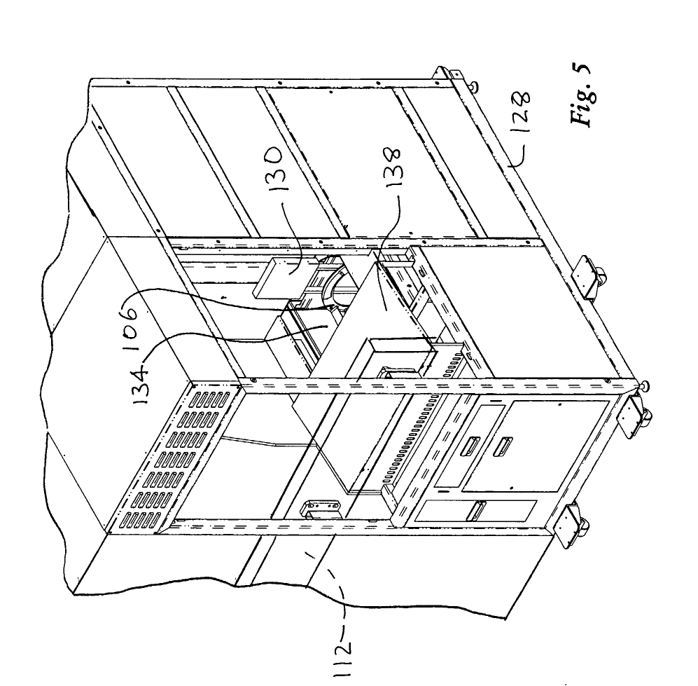

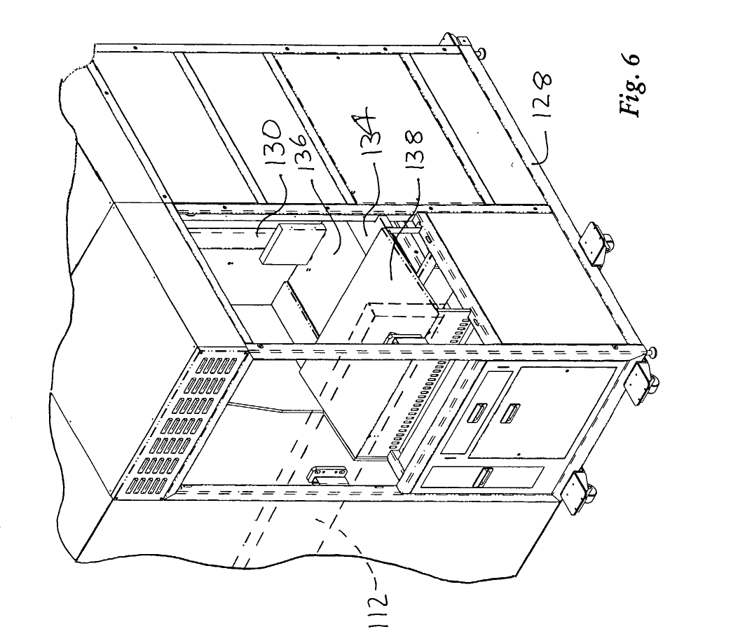

Referring to FIGS. 3-6, the immersion module 54 has a frame 128 which may be part of the system enclosure 22, or which may be separate from the enclosure 22, so that the immersion module may also act as a stand alone unit. The rail 112 supporting the process robot 110 extends through and across the open front section of the frame 128. A platform or end effector 132 adapted to hold a carrier 106 is attached to an immersion elevator 130. The immersion elevator 130 is positioned to lower the end effector 132 holding a carrier 106 into a tank 134 containing a bath of liquid. The liquid in the tank 134 is provided, maintained and controlled by a tank liquid supply system 140, which may include heaters, fitters, valves, sensors, and other liquid flow or process control components. A drip shield 138 extends forward from the tank 134 to the rear of the rail 112. A tank cover or door 136 slides rearwardly over the tank 134, to better contain vapor emissions from the tank.

In use, an operator carries or transfers a pod 65 to the loader 44, preferably by holding the handles 67. An automated or robotic pod delivery system may also be used to deliver a pod 65 to the loader 44. The pod 65 is placed onto the load elevator 60. The controller 80 is preferably pre-programmed with a specific wafer processing and handling sequence. The elevator 60 lowers the pod from the load position down to the indexer 46.

The wafers 68 are enclosed, and generally sealed within the pod 65, to protect the wafers 68 from contamination and damage during handling and movement. The pod door 66 closes or seals off the open front end of the pod 65.

With the pod 65 level with the indexer 46, the conveyor 78 supporting the pod 65 is actuated. The drive rollers 55 drive the pod 65 rearwardly, while the idler rollers 57 help to support the pod 65, thereby moving the pod 65 from the conveyor 78 onto the indexer 46.

In most applications, multiple pods 65 will be loaded into the indexer 46 and system 20, although the system may also operate with just a single pod 65. In a typical operating sequence, additional pods 65 are loaded into the indexer 46, as described above. As each subsequent pod 65 is loaded, the drive rollers 55 in the conveyor 74 in the load row 70 of the indexer 46 are actuated. The pod(s) continue to move rearwardly in the indexer 46, to the docking conveyor 84.

The docking station elevator 84 then lifts the pod 65 off of the conveyor 84 and raises the pod vertically up to the docking station 48. Specifically, the engager plate 88 on the elevator 86 engaging corresponding holes in the bottom of the pod 65.

Once the pod 65 is raised to the level of the docking station 48, the engager actuator 90 moves the pod 65 forward, so that the front surface of the pod contacts the docking wall 92, to dock the pod. The pod door remover 100 engages the pod door 66 through the opening 96 in the docking wall 92. Suction cups on the pod door remover 100 hold the pod door 66 onto the pod door remover 100, while keys extend into the pod door 66 and rotate, to unlock or release the latching mechanism which holds the pod door 66 onto the pod 65. The pod door remover 100 then moves forward, carrying the pod door 66 with it through the opening 96. The pod door remover 100, carrying the pod door 66, then moves down through the door slot 112. The front of the pod 65 is then opened to the process space 42.

The transfer robot 104 in the transfer station 50 moves its end effector 110 through the opening 96 to engage a wafer 68 within the docked pod 65. The robot 104 withdraws the wafer 68 from the pod 65 and places the wafer into a carrier 106. The robot 104 optionally passes the wafer 68 over a reader/scanner 980, to allow the controller 80 to identify that wafer, e.g., via a bar code on the bottom surface of the wafer.

Preferably, the transfer robot 104 transfers wafers between the pod 65 in row CC and the carrier 106 in row CC which is aligned with that pod, in the longitudinal direction. While cross-over wafer transfer movement between rows CC and DD may optionally be carried out, such that a wafer is transferred to a carrier 106 diagonally opposed from the pod, straight or parallel wafer movement within each row CC and DD is preferred.

The transfer robot 104 continues transferring wafers from the docked pod 65 to the carrier 106, preferably until all wafers have been transferred from the pod 65. The pod 65 and carrier 106 typically hold 25 wafers.

With the carrier 106 now loaded with wafers 68, the process robot 110 moves to engage the loaded carrier 106. The robot 110 moves laterally on the rail 112 so that the robot arm 114 is adjacent to the carrier 106. With the arm at an elevated position, the fingers 116 of the end effector 122 are pointed down and are aligned with finger slots 117 in the carriers 106. This alignment is performed by moving the robot to the proper position on the rail 112, and with proper control of the segments of the arm 114, via the controller 80.

The arm 114 of the process robot 110 then moves vertically down, with the end effector 122 engaging into the slots 117 and hooks of the carrier 106. A locking pin 118, or other securing device, is actuated, to positively secure the carrier 106 onto the end effector 122. The robot arm 114 then lifts the carrier 106 off of the deck 94, pivots the carrier 106 clockwise, moves the carrier 106 forward (towards the front wall 26) and then moves the carrier 106 laterally along the rail 112.

Depending on the process steps to be performed, the process robot 110 moves the loaded carrier to the immersion module 54, or to one of the spin process modules 114 or 116.

If immersion processing is to be performed first, the process robot 110 moves the carrier 106 to the immersion module 54. The process robot 110 then hands off the carrier 106 onto the platform or end effector 132 of the immersion module. The immersion elevator 130 then lowers the carrier 106 into the tank 134 of liquid. The tank door closes to reduce vapor emissions from the tank. The tank liquid supply system 140 provides and maintains the necessary characteristics of the liquid in the tank 134. At the completion of immersion processing, the tank door 136 slides open, and the immersion elevator lifts the carrier out of the tank 134. The process robot 110 then picks up the carrier 106, and moves it to one of the spin process chambers 114 or 116, for further processing, rinsing or drying.

For spin processing, after the door of the process chamber 114 or 116 is open, the robot 110 moves the carrier 106 into engagement with the rotor 120. The securing device 118 is released or withdrawn, the robot arm 114 is pulled back out of the chamber 116 or 114, the chamber door is closed, and the wafers 68 are processed within the carrier 106.

After processing is complete, the robot 110 retrieves the carrier 106 from e.g., the process chamber 114, and installs it into a subsequent process chamber, such as process chamber 116. In the interim, the robot 110 may move back to the transfer station 50 and pick up another carrier 106 and place it into a process chamber or into the immersion module for processing. When processing is complete, the robot 110 removes the carrier 106 from the last process chamber to be used, e.g., a spin rinser dryer process chamber, such as chamber 116, and then replaces the carrier 106 into the transfer station 50, typically in row DD. The transfer robot 104 in row DD then transfers the wafers 68 from the carrier 106 back into a docked pod 65, in row DD.

While two spin modules 114 and 116, and one immersion module 54 are shown, the system 20 may operate with 1, 2, 3, or more process modules. The immersion module 54 may also be configured for immersion processing of two carriers, simultaneously.

After the loading of processed wafers into the pod 65 in row DD is complete, the pod door remover 100 replaces the pod door 66 onto the pod 65. The engager actuator 90 moves the pod back, to undock the pod from the docking wall 92. The elevator 86 then lowers the pod back down onto the docking elevator conveyor 84. The pod now holding processed wafers is then moved forward on the conveyor 76, through the indexer 46 and into the unload elevator 62 of the loader 44. The pod is then rotated by the pod rotator 45 and lifted by the elevator 62 to the output position. The operator then lifts the pod 65 off of the unload elevator 62 and carries the pod to the next station or storage location. Alternatively, the pod 65 may be removed from the unload elevator 62 by a robot or other automation.

In typical operation of the system 20, pods 65 cycle through the indexer 46, docking station 48, transfer station 50, and process station 52, in a step by step cycle, with the pods always moving forward through the cycle. However, for certain applications, the system 20 may be operated in other ways.

The conveyors can all operate in either direction, to move pods longitudinally forward or backward within their rows 70 or 72. The shuttle robots 82 allow for lateral movement of pods between the rows 70 and 72. Consequently, the indexer 46 can provide random pod access, i.e., a pod can be moved from any position, to any other position.

To reduce contamination, clean air is made to flow downwardly, from top to bottom through the system 20. The deck 94 preferably has openings in it to allow air to flow downwardly. Alternatively, the deck 94 may be removed entirely, with air flow used to reduce contamination, rather than separation of spaces by a deck or wall. In an embodiment having no deck 94, the indexer space and process space are combined into a single system space. The docking wall 92 then serves as a surface for docking pods, rather than as a barrier to contamination.

By locating the indexer 46 largely underneath the docking station 48 and transfer station 50, a compact design requiring less floor space, is achieved.

The controller 80 is preferably electrically connected to the various robots, motors, sensors, and actuators involved in performing the functions of the system 20, so that the various components can be controlled in coordination and system performance controlled and monitored.

Thus, while a single embodiment has been shown and described, various changes and substitutions may of course be made, without departing from the spirit and scope of the invention. The invention, therefore, should not be limited, except by the following claims, and their equivalents.

What is claimed is:

1. A system for processing wafers, comprising:
an indexer at a first elevation;
a docking station at a second elevation higher than the first elevation;
a transfer station adjacent to the docking station;
a centrifugal process module;
an immersion process module;
and a robot movable between the transfer station and the centrifugal and immersion process stations, for moving wafers between them.

2. The system of claim 1 further comprising a carrier adapted to be loaded with wafers at the transfer station, and for installation into the centrifugal and immersion process modules.

3. The system of claim 2 with the immersion module including an end effector for holding the carrier, an immersion tank, and an immersion elevator positioned to raise and lower the carrier into and out of the tank.

4. The system of claim 3 further comprising a tank door moveable from an open position, for movement of a carrier into or out of the tank, to a closed position, wherein the tank door at least partially closes off the top of the tank.

5. A method for processing at least one wafer contained within a closed pod, comprising the steps of:
removing the at least one wafer from the pod;
transferring the at least one wafer into a carrier, while maintaining the at least one wafer in a substantially horizontal orientation;
engaging the carrier with a robot arm;
moving the robot with the carrier to an immersion processor;
placing the carrier onto an elevator in the immersion processor;
lowering the carrier into a bath of liquid, via the elevator.

6. The method of claim 5 further including the step of closing off the tank.
